(19) United States
(12) Patent Application Publication
(10) Pub. No.: US 2024/0378785 A1
(43) Pub. Date: Nov. 14, 2024

(54) INFORMATION PROCESSING DEVICE AND INFORMATION PROCESSING METHOD

(71) Applicant: SONY GROUP CORPORATION, TOKYO (JP)

(72) Inventor: LEONARDO ISHIDAABE, TOKYO (JP)

(21) Appl. No.: 18/554,487

(22) PCT Filed: Mar. 29, 2022
(86) PCT No.: PCT/JP2022/015278

§ 371 Date: Oct. 9, 2023

(30) Foreign Application Priority Data
Apr. 22, 2021 (JP) 2021-072683

(51) Int. Cl. G06T 13/40; G06T 7/246

(52) U.S. Cl. CPC G06T 13/40; G06T 7/246

(57) ABSTRACT

A high-quality animation image is generated by a simple procedure without requiring complicated processing, a high-performance processor, or the like. An information processing device includes a first imaging unit that captures an image of an entire effective pixel region at a predetermined frame rate, a second imaging unit that captures an image of a pixel in which an event has occurred, a first data generation unit that generates data for converting a two-dimensional image captured by the first imaging unit into a three-dimensional image, a feature point tracking unit that detects a feature point included in the image captured by the second imaging unit and tracks movement of the detected feature point, a second data generation unit that generates data for a partial animation image simulating movement of the feature point on the basis of a tracking result of the movement of the feature point, and an information exchange unit that exchanges at least a part of the data generated by the first data generation unit with at least a part of the data generated by the second data generation unit.

### TECHNICAL FIELD

The present disclosure relates to an information processing device and an information processing method.

### BACKGROUND ART

Unlike a normal camera, an event camera captures only pixel information in which an event such as a luminance change occurs, and thus has a feature that event information can be acquired at high speed with a small data amount. A technique for tracking movement of a deformable object at high speed using the event camera has been proposed (Patent Document 1).

### CITATION LIST

### Patent Document

Patent Document 1: WO 2019/099337

### SUMMARY OF THE INVENTION

### Problems to be Solved by the Invention

While Patent Document 1 aims to capture movement of a deformable object using an event camera, the event camera can detect a luminance change at high speed and with high accuracy but cannot acquire pixel information without a luminance change, and cannot acquire color information of an object. Thus, the technique of Patent Document 1 cannot generate a high-definition two-dimensional image.

Recently, a technique of extracting a feature point from a two-dimensional image captured by a normal camera and generating a three-dimensional image or an animation image using the extracted feature point as a clue has attracted attention. The event camera is superior to the normal camera in terms of extraction and tracking of moving feature points, and by using the event camera, moving feature points can be tracked with high accuracy. On the other hand, since a feature point without movement cannot be detected by the event camera, it is necessary to detect the feature point from an image captured by the normal camera.

As described above, the normal camera and the event camera have advantages and disadvantages, and it is difficult to generate a three-dimensional image or an animation image of a moving subject only with one of them.

Accordingly, the present disclosure provides an information processing device and an information processing method capable of generating a high-quality animation image in a simple procedure without requiring complicated processing, a high-performance processor, and the like.

### Solutions to Problems

In order to solve the above problem, according to one aspect of the present disclosure, there is provided an information processing device, including:
a first imaging unit that captures an image of an entire effective pixel region at a predetermined frame rate;
a second imaging unit that captures an image of a pixel in which an event has occurred;
a first data generation unit that generates data for converting a two-dimensional image captured by the first imaging unit into a three-dimensional image;
a feature point tracking unit that detects a feature point included in the image captured by the second imaging unit and tracks movement of the detected feature point;
a second data generation unit that generates data for a partial animation image simulating movement of the feature point on the basis of a tracking result of the movement of the feature point; and an information exchange unit that exchanges at least a part of the data generated by the first data generation unit with at least a part of the data generated by the second data generation unit.

The first data generation unit may generate data for converting the two-dimensional image into a three-dimensional image on the basis of the two-dimensional image captured by the first imaging unit and at least a part of the data generated by the second data generation unit provided from the information exchange unit, and
the second data generation unit may generate the data for the partial animation image on the basis of a tracking result of the movement of the feature point and at least a part of the data generated by the first data generation unit provided from the information exchange unit.

The first imaging unit and the second imaging unit may capture an image of a face of a subject, and
the information exchange unit may provide the second data generation unit with data regarding at least one of a pose of a head or a line-of-sight direction of the subject included in the data generated by the first data generation unit, and provide the first data generation unit with data regarding at least one of movement of an eye or a mouth or a state change of skin of the subject included in the data generated by the second data generation unit.

The information exchange unit may receive provision of different types of data from each of the first data generation unit and the second data generation unit, and exchange data between the first data generation unit and the second data generation unit.

The information exchange unit may receive provision of a same type of data from each of the first data generation unit and the second data generation unit, and shares highly reliable data among provided data between the first data generation unit and the second data generation unit.

The second imaging unit may output an image including a pixel in which the event has occurred at a higher frame rate than the first imaging unit.

The second imaging unit may output the image in accordance with timing at which the event occurs.

An animation generation unit that generates a first animation image on the basis of the data generated by the first data generation unit and the second data generation unit with which at least a part of data has been exchanged by the information exchange unit may be further included.

The animation generation unit may generate the first animation image by synthesizing the partial animation image generated by the second data generation unit with a three-dimensional image generated by the first data generation unit.

An image synthesis unit that synthesizes the first animation image and a three-dimensional animation model image to generate a second animation image may be further included.

The three-dimensional animation model image may be a three-dimensional animation image independent of a subject imaged by the first imaging unit and the second imaging unit.

The first animation image and the second animation image may perform movement according to movement of a subject.

The first data generation unit may extract a feature point from a two-dimensional image captured by the first imaging unit, and generates the three-dimensional image on the basis of the extracted feature point.

The first data generation unit may extract a face included in the two-dimensional image captured by the first imaging unit, and generates the three-dimensional image on the basis of at least one of a feature point of the extracted face, a pose of a head, or a line-of-sight direction.

The feature point tracking unit may track the feature point by detecting movement of the feature point between images of different frames captured by the second imaging unit.

The second data generation unit may include a frame rate conversion unit that generates the partial animation image in which a frame rate of the image captured by the second imaging unit is lowered to a frame rate suitable for an animation image.

The second data generation unit may include
a feature point image generation unit that generates a three-dimensional image corresponding to the image captured by the second imaging unit,
a surface normal calculation unit that calculates a surface normal of the three-dimensional image,
an object detection unit that detects an object included in the three-dimensional image,
a region-of-interest extraction unit that extracts a region of interest included in the three-dimensional image, and
a feature point extraction unit that extracts a feature point included in the three-dimensional image, and
the second data generation unit may generate data for the partial animation image simulating movement of the feature point on the basis of the three-dimensional image generated by the feature point image generation unit, the surface normal calculated by the surface normal calculation unit, the object detected by the object detection unit, the region of interest extracted by the region-of-interest extraction unit, and the feature point extracted by the feature point extraction unit.

A plurality of at least one of the first imaging units or the second imaging units may be provided.

A third imaging unit that is provided separately from the first imaging unit and the second imaging unit and captures an image including at least one of depth information of a subject, distance information to the subject, or temperature information of the subject may be further included, in which
at least one of the first data generation unit or the second data generation unit may generate at least one of data to be converted into a three-dimensional image or data for the partial animation image on the basis of an image captured by the third imaging unit.

According to another aspect of the present disclosure, there is provided an electronic device including:
an information processing device that generates a three-dimensional animation image; and
a display device that displays the three-dimensional animation image, in which
the information processing device includes
a first imaging unit that captures an image of an entire effective pixel region at a predetermined frame rate,
a second imaging unit that captures an image of a pixel in which an event has occurred,
a first data generation unit that generates data for converting a two-dimensional image captured by the first imaging unit into a three-dimensional image,
a feature point tracking unit that detects a feature point included in the image captured by the second imaging unit and tracks movement of the detected feature point,
a second data generation unit that generates data for a partial animation image simulating movement of the feature point on the basis of a tracking result of the movement of the feature point,
an information exchange unit that exchanges at least a part of the data generated by the first data generation unit with at least a part of the data generated by the second data generation unit,
an animation generation unit that generates a first animation image on the basis of the data generated by the first data generation unit and the second data generation unit with which at least a part of data has been exchanged by the information exchange unit, and
an image synthesis unit that synthesizes the first animation image and a three-dimensional animation model image to generate a second animation image, and
the display device displays the second animation image.

### BRIEF DESCRIPTION OF DRAWINGS

FIG. 1 is a block diagram illustrating a schematic configuration of an information processing device according to an embodiment.

FIG. 2 is a flowchart illustrating a procedure of processing of generating a three-dimensional image from a two-dimensional image using GAN.

FIG. 3 is a view illustrating an example of a three-dimensional image obtained by mesh-dividing a face image.

FIG. 4 is a block diagram illustrating an internal configuration of a second data generation unit.

FIG. 5 is a block diagram illustrating a first specific example of an information exchange unit.

FIG. 6 is a diagram illustrating an example in which information of feature points is provided from a first data generation unit to the second data generation unit via the information exchange unit.

FIG. 7 is a diagram illustrating an example in which the second data generation unit provides the first data generation unit with information such as movement of an eye or a mouth and a state change of skin via the information exchange unit.

FIG. 8A is a diagram illustrating an example in which human left and right eyes are extracted from a face image and a pose of a head is detected.

FIG. 8B is a diagram illustrating an example in which a plurality of feature points is extracted from a human face image, and a pose of a head is extracted.

FIG. 9 is a diagram illustrating examples of a partial animation image generated by the second data generation unit.

FIG. 10 is a block diagram illustrating a second specific example of the information exchange unit.

FIG. 11 is a block diagram illustrating an example of a hardware configuration of an information processing device according to the present disclosure.

FIG. 12 is a block diagram illustrating a schematic configuration of an information processing device according to a first use case.

FIG. 13 is a diagram illustrating participants of a virtual conference system.

FIG. 14 is a block diagram illustrating a schematic configuration of an information processing device according to a second use case.

FIG. 15 is a diagram illustrating a human wearing VR glasses or an HMD.

FIG. 16 is a block diagram illustrating a schematic configuration of an information processing device according to a third use case.

FIG. 17A is a block diagram of an information processing device 1 including a camera having a special function and a third processing processor in addition to a frame camera and an event camera.

FIG. 17B is a block diagram of an information processing device according to a modification of FIG. 17A.

### MODE FOR CARRYING OUT THE INVENTION

Hereinafter, embodiments of an information processing device and an information processing method will be described with reference to the drawings. Although main components of the information processing device and the information processing method will be mainly described below, the information processing device and the information processing method may include components and functions that are not illustrated or described. The following description does not exclude components and functions that are not illustrated or described.

### (Overall Configuration of Information Processing Device)

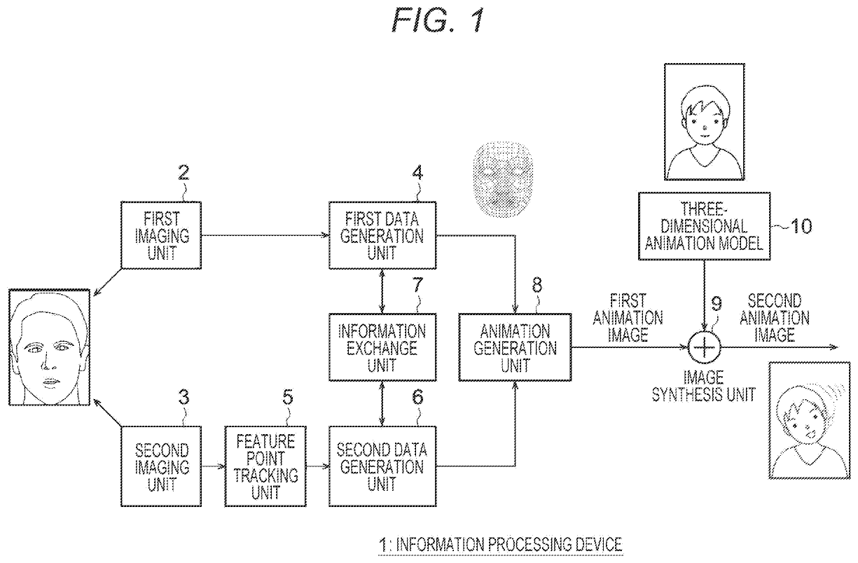

FIG. 1 is a block diagram illustrating a schematic configuration of an information processing device 1 according to an embodiment. The information processing device 1 of FIG. 1 includes a first imaging unit 2, a second imaging unit 3, a first data generation unit 4, a feature point tracking unit 5, a second data generation unit 6, and an information exchange unit 7 as necessary components.

The first imaging unit 2 captures an image of the entire effective pixel region at a predetermined frame rate. The first imaging unit 2 is a normal image sensor that captures RGB gradation information or a camera (hereinafter, it may be referred to as a frame camera) incorporating the image sensor. The first imaging unit 2 may have a function of changing the frame rate. The first imaging unit 2 may capture gradation information in a monochromatic wavelength region. For example, the first imaging unit 2 may capture an image of light in an infrared wavelength region.

The second imaging unit 3 captures an image of a pixel in which an event has occurred. Here, the event indicates, for example, that a luminance change exceeds a threshold. The luminance change may be an absolute value. In a case where a luminance change from a low luminance state to a high luminance state exceeds a threshold, and in a case where a luminance change from a high luminance state to a low luminance state exceeds a threshold, it may be determined that an event has occurred. In addition, a plurality of thresholds may be provided so that a plurality of types of events can be detected. Moreover, it may be determined that an event has occurred in a case where the amount of received light exceeds a threshold or in a case where the amount of received light falls below the threshold, instead of a luminance change. Furthermore, a threshold for event detection may be adjustable. By adjusting the threshold, the dynamic range of the second imaging unit 3 can be expanded.

Since the second imaging unit 3 captures an image of only pixels in which an event has occurred and does not image pixels in which no event has occurred, the image size for each frame can be reduced. While each of images captured by the first imaging unit 2 and the second imaging unit 3 is stored in a storage unit (not illustrated), since an image size captured by the second imaging unit 3 is much smaller than an image size captured by the first imaging unit 2, the frame rate of the second imaging unit 3 can be increased accordingly, and imaging at a higher speed can be performed.

The second imaging unit 3 includes a sensor having a function of detecting, for each pixel, whether or not the amount of received light or the luminance change exceeds the threshold. This type of sensor may be referred to as, for example, an event base vision sensor (EVS) or a dynamic vision sensor (DVS).

The first data generation unit 4 generates data for converting a two-dimensional image captured by the first imaging unit 2 into a three-dimensional image. For example, the first data generation unit 4 extracts feature points (keypoints) from the two-dimensional image captured by the first imaging unit 2, and generates a three-dimensional image on the basis of the extracted feature points. In the process of generating the three-dimensional image, learning may be performed using a convolutional neural network (CNN) or a deep neural network (DNN).

As a more specific example, the first data generation unit 4 extracts a face included in the two-dimensional image captured by the first imaging unit 2, performs learning on the basis of at least one of the extracted feature points of the face, a head pose, or a line of sight (gaze), and then generates a three-dimensional image.

The feature point tracking unit 5 detects a feature point included in an image captured by the second imaging unit 3 and tracks movement of the detected feature point. More specifically, the feature point tracking unit 5 tracks the feature points by detecting movement of the feature point between images of different frames captured by the second imaging unit 3.

The second data generation unit 6 generates data for a partial animation image simulating movement of the feature point on the basis of a tracking result of movement of the feature point. The second data generation unit 6 decreases the frame rate of the image captured by the second imaging unit 3 to a frame rate suitable for an animation image. Details of an internal configuration of the second data generation unit 6 will be described later.

The feature point may also be referred to as a keypoint or a density. In addition, the process of detecting movement of the feature point between frames may be referred to as an optical flow. The feature point tracking unit 5 extracts a feature point with the keypoint and density, and tracks the feature point using, for example, an optical flow.

The information exchange unit 7 exchanges at least a part of the data generated by the first data generation unit 4 with at least a part of the data generated by the second data generation unit 6. Thus, the information exchange unit 7 can complement at least a part of the data generated by the first data generation unit and the data generated by the second data generation unit.

The information exchange unit 7 may receive provision of different types of data from each of the first data generation unit 4 and the second data generation unit 6, and exchange data between the first data generation unit 4 and the second data generation unit 6.

Alternatively, the information exchange unit 7 may receive the same type of data from each of the first data generation unit 4 and the second data generation unit 6, and share highly reliable data among the provided data between the first data generation unit 4 and the second data generation unit 6.

For example, the information exchange unit 7 can provide the second data generation unit with information of the pose of a head and a line-of-sight direction (gaze) detected by the first data generation unit 4, and can provide the first data generation unit with information of movement of eyes and a mouth detected by the second data generation unit 6, information of a state change of the skin, and the like. The first data generation unit 4 can generate a three-dimensional image by using the information of the movement of eyes and mouth, the information of the state change of the skin, and the like provided from the second data generation unit 6 via the information exchange unit 7. The second data generation unit 6 can generate data for a partial animation image by using the information of the pose of the head (pose) and the line-of-sight direction (gaze) provided from the first data generation unit 4 via the information exchange unit 7.

In this manner, by providing the information exchange unit 7 and allowing the first data generation unit 4 and the second data generation unit 6 to exchange at least a part of data with each other, the quality of the three-dimensional image generated by the first data generation unit 4 and the partial animation image generated by the second data generation unit 6 can be improved.

The information processing device 1 in FIG. 1 may include an animation generation unit 8. The animation generation unit 8 generates a first animation image on the basis of the data generated by the first data generation unit 4 and the second data generation unit 6 which have exchanged at least a part of the data by the information exchange unit 7. More specifically, the animation generation unit 8 generates the first animation image by synthesizing the partial animation image generated by the second data generation unit 6 with the three-dimensional image generated by the first data generation unit 4.

The first animation image may be a face image or an image other than a face such as a hand or a foot. Furthermore, the first animation image is not necessarily an image of a human or an animal, and may be an image of an arbitrary object such as a vehicle.

The information processing device 1 of FIG. 1 may include an image synthesis unit 9. The image synthesis unit 9 synthesizes the first animation image and a three-dimensional animation model 10 to generate a second animation image. The three-dimensional animation model 10 is a three-dimensional animation image prepared in advance, and is an image independent of the subject captured by the first imaging unit 2 and the second imaging unit 3. Thus, the subject imaged by the first imaging unit 2 and the second imaging unit 3 can be replaced with any animation model image, and movement simulating movement of, for example, the eyes or mouth of the subject can be reflected in the animation model image. Therefore, the eyes, mouth, head, and the like of the animation image can be moved in accordance with the movement of the eyes, mouth, head, and the like of the subject.

### (Processing of First Data Generation Unit 4)

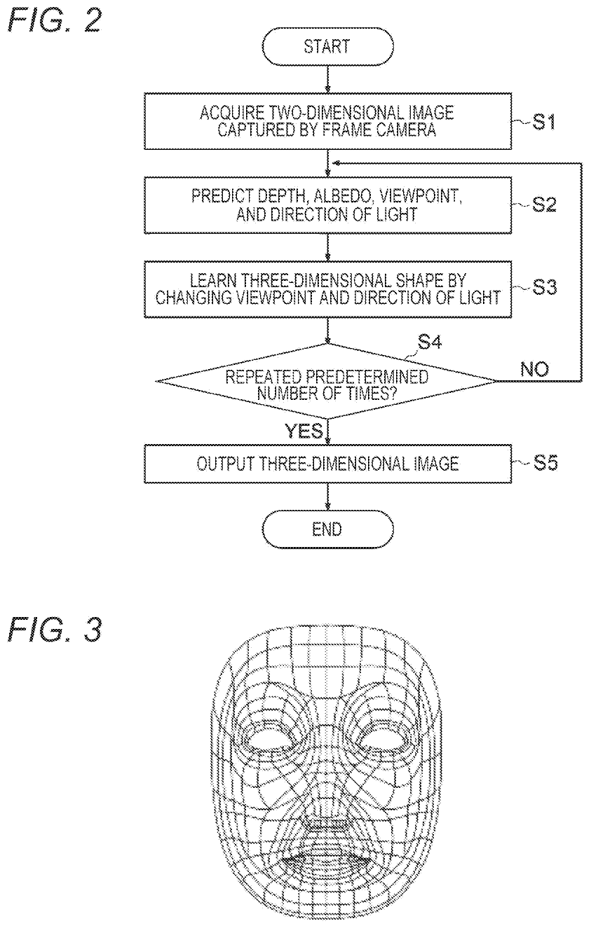

The first data generation unit 4 generates a three-dimensional image on the basis of the two-dimensional image captured by the first imaging unit 2. The specific processing content for generating the three-dimensional image from the two-dimensional image is not limited. Hereinafter, processing using a Generative Adversarial Network (GAN) will be described as an example. FIG. 2 is a flowchart illustrating a procedure of processing of generating a three-dimensional image from a two-dimensional image using the GAN. First, a two-dimensional image captured by the first imaging unit 2 corresponding to the frame camera is acquired (step S1). Next, depth information, albedo (reflectivity) information, viewpoint information, and a light direction are predicted on the basis of the acquired two-dimensional image (step S2). Here, learning is performed to convert a two-dimensional image into a three-dimensional image using depth information, albedo information, and a direction of light, project the three-dimensional image onto the two-dimensional image, compare the three-dimensional image with the original two-dimensional image, and update the depth information, the albedo information, and the direction of light so that a comparison result becomes the same.

Next, the three-dimensional shape of the three-dimensional image generated in step S2 is learned by changing the viewpoint information and the light direction (step S3). For the learning, CNN, DNN, or the like can be used.

Next, it is determined whether or not the processing of steps S2 and S3 described above has been repeated a predetermined number of times (step S4), and the three-dimensional image made to repeatedly learn a predetermined number of times is finally output.

In performing the processing of the first data generation unit 4, feature points may be extracted from the two-dimensional image captured by the first imaging unit 2, depth information may be estimated on the basis of the feature points, and the three-dimensional image may be generated using the estimated depth information. The feature points are the contour of the face, the mouth, the nose, the ears, the eyebrows, the chin, and the like. As illustrated in FIG. 3, the face may be divided into a mesh shape from the feature point and the depth information, and the three-dimensional information may be represented by a curved shape of a lattice line of the mesh. In addition, the feature point may be extracted on the basis of a characteristic shape in the two-dimensional image, or the feature point may be extracted on the basis of a density of dots in the two-dimensional image.

Since the processing of the first data generation unit 4 is performed on the basis of the two-dimensional image including the information of all the pixels in the effective pixel region, the feature points in the two-dimensional image can be extracted without omission although the processing may take time. Furthermore, since the two-dimensional image includes color gradation information, feature points having a characteristic color can also be extracted, and a three-dimensional image including the color gradation information can be generated.

On the other hand, the quality of the three-dimensional image changes depending on the resolution of the two-dimensional image captured by the first imaging unit 2 and the processing performance of the first data generation unit 4. In particular, in a case where at least a part of the subject is moving, how accurately the movement can be expressed in the three-dimensional image depends on an algorithm that performs processing of converting the two-dimensional image into the three-dimensional image in the first data generation unit 4, and when a complicated algorithm is employed, it takes a lot of time to generate the three-dimensional image.

In general, feature points having a characteristic shape can be extracted relatively easily, but it is difficult to extract a state change of the skin or muscles or the like as a feature point. Furthermore, in the extraction of the feature points based on dense information, it is possible to extract features of detailed parts such as state changes of the skin and muscles, but the processing takes time.

A camera equipped with a normal image sensor can obtain only a two-dimensional image of about 30 frames/second. At about 30 frames/second, there is a possibility that the animation image cannot be smoothly moved, and it is necessary to further increase the frame rate. Furthermore, by a camera equipped with a normal image sensor, it is difficult to faithfully track the movement of a fast moving object, and it is not possible to faithfully reproduce the movement of the object in a three-dimensional image.

### (Processing of Second Data Generation Unit 6)

Since the second imaging unit 3 captures an image of a pixel in which an event such as the amount of received light or a luminance change exceeding a threshold occurs, the feature point tracking unit 5 can relatively easily extract a moving feature point from the image captured by the second imaging unit 3. Furthermore, the feature point tracking unit 5 can track a feature point by comparing images captured by the second imaging unit 3 of a plurality of frames. As described above, the feature point may be either a feature point having a characteristic shape or a feature point having a characteristic brightness gradation (density).

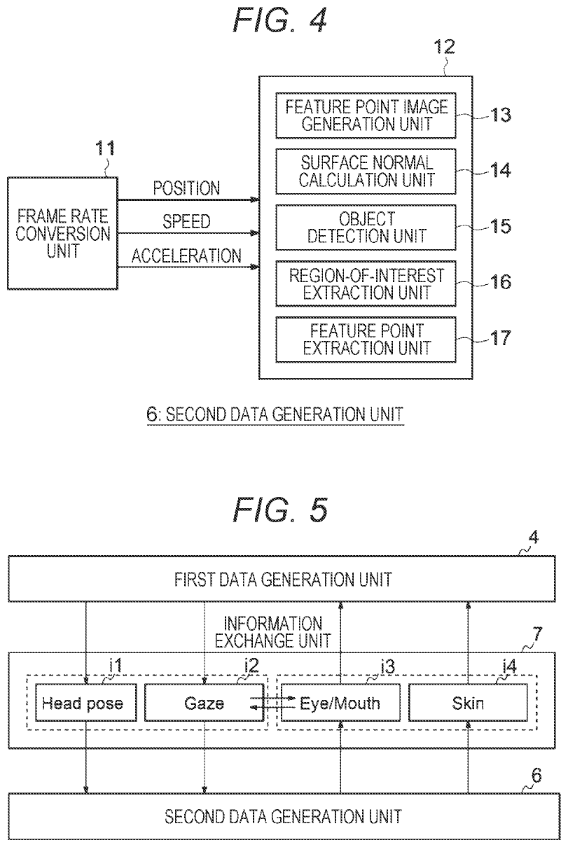

FIG. 4 is a block diagram illustrating an internal configuration of the second data generation unit 6. As illustrated in FIG. 4, the second data generation unit 6 includes a frame rate conversion unit 11 and a processing module 12.

The frame rate conversion unit 11 reduces the frame rate of the image captured by the second imaging unit 3 to a frame rate suitable for an animation image. Since the second imaging unit 3 generates an image including only pixels in which an event has occurred, the frame rate can be increased, and for example, a frame rate exceeding 10,000 frames/second can also be achieved. On the other hand, an animation image of about 1,000 frames/second is sufficient. Accordingly, the frame rate conversion unit 11 converts the frame rate of the image captured by the second imaging unit 3 to a frame rate that allows the animation image to move smoothly.

The processing of the frame rate conversion unit 11 is also referred to as time binning processing. More specifically, the frame rate conversion unit 11 outputs position information, speed information, and acceleration information indicating the tracking result of the feature point. These pieces of information are input to the processing module 12.

The processing module 12 in FIG. 4 includes a feature point image generation unit 13, a surface normal calculation unit 14, an object detection unit 15, a region-of-interest extraction unit 16, and a feature point extraction unit 17.

The feature point image generation unit 13 generates a three-dimensional image corresponding to the image captured by the second imaging unit 3. The surface normal calculation unit 14 calculates a surface normal of the three-dimensional image. For example, the surface normal calculation unit 14 calculates the surface normal from the movement of the object. The object detection unit 15 detects an object included in the three-dimensional image. The region-of-interest extraction unit 16 extracts a region of interest (ROI) included in the three-dimensional image. The feature point extraction unit 17 extracts feature points included in the three-dimensional image.

The second data generation unit 6 generates data for a partial animation image simulating the movement of a feature point on the basis of the three-dimensional image generated by the feature point image generation unit 13, the surface normal calculated by the surface normal calculation unit 14, the object detected by the object detection unit 15, the region of interest extracted by the region-of-interest extraction unit 16, and the feature point extracted by the feature point extraction unit 17.

The second data generation unit 6 may generate an animation image (particle-based animation) in units of particles on the basis of the image data obtained by converting the frame rate. Instead of the feature points, the mesh of the three-dimensional image may be reconstructed on the basis of the particle.

Since the second imaging unit 3 generates an image including only pixels in which an event has occurred, the frame rate can be increased. Specifically, the second imaging unit 3 can also acquire images at a frame rate of 10,000 frames/second or more. Furthermore, by detecting a pixel whose luminance exceeds a first threshold and a pixel whose luminance falls below a second threshold, the dynamic range can be expanded, and for example, a pixel whose luminance is very high and a pixel whose luminance is very low can be detected.

On the other hand, the second data generation unit 6 can detect only a pixel having a large luminance change, and cannot detect information of a pixel having no luminance change or color information of each pixel. Furthermore, currently, the resolutions of commercially available event cameras and sensors for event detection are less than full HD (for example, 1080×720), and there is a problem that a high-resolution three-dimensional image of 4K, 8K, or the like cannot be generated from the image captured by the second imaging unit 3.

### (Processing of Information Exchange Unit 7)

The information exchange unit 7 exchanges data generated by the first data generation unit 4 and the second data generation unit 6 with each other. The first data generation unit 4 can provide, for example, detailed feature (high texture) information, color information, high resolution information, and the like to the second data generation unit 6 via the information exchange unit 7. The second data generation unit 6 can provide a high frame rate image captured by the second imaging unit 3, density information indicating a fine luminance change in the image, event information with a wide dynamic range, and the like to the first data generation unit 4 via the information exchange unit 7.

In a more specific example, the first data generation unit 4 provides data regarding at least one of the pose of the head or the line-of-sight direction (gaze) to the second data generation unit 6 via the information exchange unit 7. The second data generation unit 6 provides the first data generation unit 4 with data regarding at least one of movement of an eye or a mouth or a state change of the skin. Thus, the first data generation unit 4 and the second data generation unit 6 can generate high-quality three-dimensional images and partial animation images.

Hereinafter, two specific examples of processing of the information exchange unit 7 will be described.

### (First Specific Example of Information Exchange Unit 7)

In a first specific example of the information exchange unit 7, different types of information generated by the first data generation unit 4 and the second data generation unit 6 are exchanged with each other.

FIGS. 5 to 7 are block diagrams illustrating a first specific example of the information exchange unit 7. In the first specific example of the information exchange unit 7, the first imaging unit 2 and the first data generation unit 4 are used to obtain macro information of the subject, and the second imaging unit 3, the feature point tracking unit 5, and the second data generation unit 6 are used to obtain micro information of the subject.

The first imaging unit 2 captures a two-dimensional image including color gradation information for the entire region of the effective pixels. The first data generation unit 4 extracts feature points included in the two-dimensional image captured by the first imaging unit 2 and generates a face model. At that time, the first data generation unit detects a pose of the head, a line-of-sight direction (gaze), and the like.

The feature point tracking unit 5 detects detailed movement of a part of the face such as an eye (presence or absence of blinking, a pupil, or the like) or a mouth on the basis of the image captured by the second imaging unit 3. In addition, the feature point tracking unit 5 may detect a movement speed of a part of the face. Moreover, the feature point tracking unit 5 may detect information such as a subtle change in the skin condition. The second data generation unit 6 generates data for the partial animation image on the basis of the feature points extracted by the feature point tracking unit 5 and the tracking result of the feature points.

At least a part of the data generated by the first data generation unit 4 is sent to the information exchange unit 7. Similarly, at least a part of the data generated by the second data generation unit 6 is sent to the information exchange unit 7. As illustrated in FIG. 5, the information exchange unit 7 associates the data generated by the first data generation unit 4 with the data generated by the second data generation unit 6. For example, information regarding a pose i1 and a line-of-sight direction (gaze) i2 of the head in the data generated by the first data generation unit 4 is associated with information regarding movement i3 of an eye or a mouth and a state change i4 of the skin in the data generated by the second data generation unit 6. Thus, for example, an eye position in the three-dimensional image generated by the first data generation unit 4 can have movement such as blinking on the basis of the data generated by the second data generation unit 6.

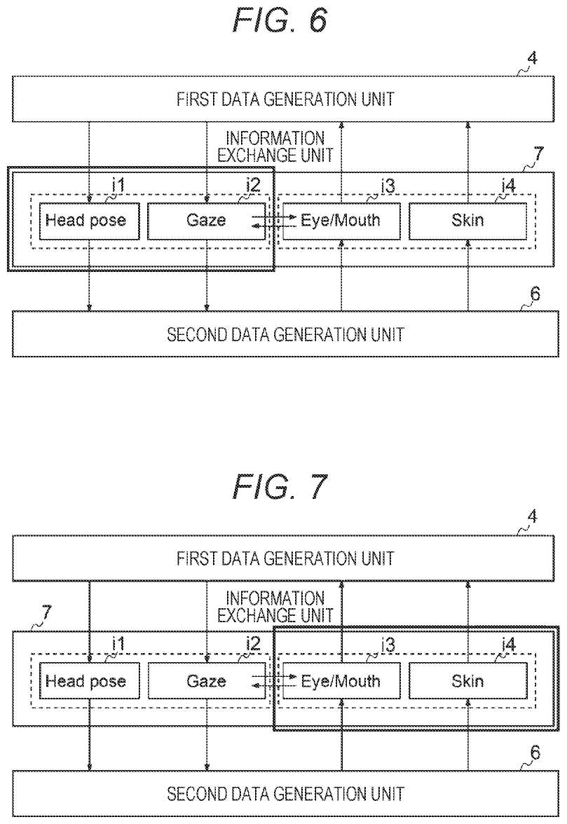

FIG. 6 illustrates an example in which the first data generation unit 4 provides the second data generation unit 6 with information of feature points such as the pose i1 and the line-of-sight direction (gaze) i2 via the information exchange unit 7.

The first data generation unit 4 extracts feature points included in the three-dimensional image generated from the two-dimensional image. The feature points include, for example, the pose i1 of the head. The pose i1 of the head is a degree of inclination of the face (head). Furthermore, the feature point includes, for example, the line-of-sight direction (gaze) i2. The line-of-sight direction (gaze) i2 is a direction toward which a human directs a line of sight.

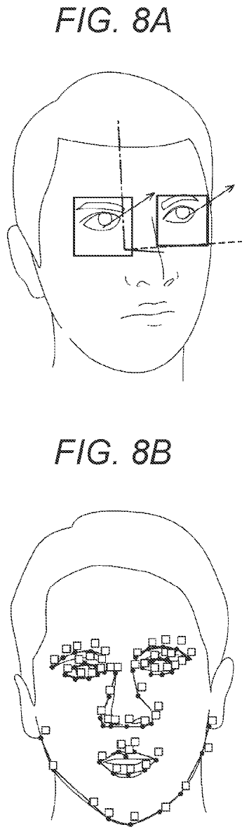

FIGS. 8A and 8B are diagrams for explaining a method in which the first data generation unit 4 detects the pose i1 of the head and the line-of-sight direction (gaze) i2. FIG. 8A illustrates an example in which human left and right eyes are extracted from the face image, and the pose i1 of the head is detected from a direction (broken line) in which the left and right eyes are arranged and the normal direction (one-dot chain line). FIG. 8B illustrates an example in which a plurality of feature points indicated by square marks is extracted from a human face image, and a pose i1 of the head is extracted from the arrangement of the feature points. For example, in FIG. 8A, the pose i1 of the head can be detected from the degree of inclination of the left eye and the right eye, the degree of inclination of the contour line of the face, and the like with respect to the horizontal direction and the vertical direction of the image. Furthermore, the pupil in the eye is extracted as a feature point, and the line-of-sight direction (gaze) i2 can be detected from the position of the pupil.

Since the second imaging unit 3 captures only the information of the pixel in which the event has occurred, there is a possibility that the pose i1 and the line-of-sight direction (gaze) i2 of the head of the subject cannot be accurately grasped from the image captured by the second imaging unit 3. Accordingly, the second data generation unit 6 can generate data for the partial animation image after correctly grasping the pose of the head and the line-of-sight direction (gaze) by receiving information of the pose of the head i1 and the line-of-sight direction (gaze) i2 included in the data generated by the first data generation unit 4 via the information exchange unit 7.

Furthermore, since color information is not included in the image captured by the second imaging unit 3, the second data generation unit 6 can generate a partial animation image including the color information by receiving the color information included in the data generated by the first data generation unit 4 via the information exchange unit 7.

Moreover, since the image captured by the second imaging unit 3 may not include contour information of the object, the second data generation unit 6 can generate a partial animation image simulating the contour of the object by receiving contour information of the object included in the data generated by the first data generation unit 4 via the information exchange unit 7.

As described above, by providing the information exchange unit 7, the second data generation unit 6 can generate a partial animation image in consideration of pixel information in which no event such as a luminance change has occurred.

FIG. 7 is a diagram illustrating an example in which the second data generation unit 6 provides the first data generation unit 4 with information such as the movement i3 of an eye or a mouth and the state change i4 of the skin via the information exchange unit 7. The movement i3 of the eye or the mouth is, for example, blinking of the eye, positional change of the pupil, opening of the mouth, and the like. The feature point tracking unit 5 tracks the movement i3 of the eye or the mouth, which is a feature point, from a plurality of images of a plurality of frames captured by the second imaging unit 3. Furthermore, the feature point tracking unit 5 detects the state change i4 of the skin from a luminance change of the skin. As a more specific example, the state change i4 of the skin while a human is speaking is detected, and a change in wrinkles, distortion of the mouth, and the like are tracked.

Since the second imaging unit 3 captures an image of a moving part at a frame rate much higher than that of the first imaging unit 2, it is possible to acquire an image that faithfully expresses movement of the eye, movement of the mouth, state change of the skin, and the like without causing blurring.

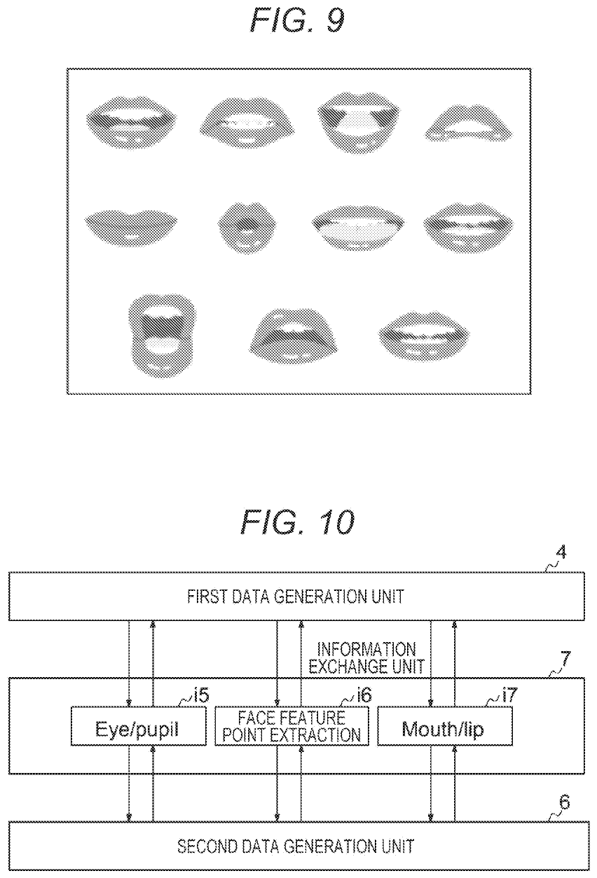

FIG. 9 is a diagram illustrating examples of a partial animation image generated by the second data generation unit 6. FIG. 9 illustrates a partial animation image related to movement of a human mouth. When the movement of the subject's mouth changes, the second imaging unit 3 captures the change as an event, so that the second data generation unit 6 can generate a partial animation in accordance with the movement of the human mouth. Even if the subject moves the eyes, mouth, or head at a high speed, the second imaging unit 3 can capture an image of the moved portion following the movement, so that the second data generation unit 6 can move the eyes, mouth, or the like of the partial animation image at a high speed in accordance with the movement of the eyes, mouth, or the like of the subject.

In the image captured by the first imaging unit 2 while the human is speaking, a moving part such as an eye or a mouth may be blurred. Accordingly, the first data generation unit 4 can eliminate blurring of a moving part in the image by receiving information such as movement of the eye and movement of the mouth included in the data generated by the second data generation unit 6 via the information exchange unit 7.

The data generated by the first data generation unit 4 includes, for example, information of a line-of-sight direction (gaze) i2. The line-of-sight direction (gaze) i2 is region of interest (ROI) information of the eye. In a case where the human does not change the line-of-sight direction (gaze) i2, the second imaging unit 3 cannot detect the line-of-sight direction (gaze) i2 as an event. Thus, the data generated by the second data generation unit 6 does not include information of the line-of-sight direction (gaze) i2. Accordingly, the second data generation unit 6 can generate the partial animation image in consideration of the line-of-sight direction (gaze) i2 by receiving the information of the line-of-sight direction (gaze) 12 from the first data generation unit 4 via the information exchange unit 7.

On the other hand, the data generated by the second data generation unit 6 includes, for example, information of the movement i3 of the eye. Since the second imaging unit 3 can capture a moving object as an event at high speed, the second data generation unit 6 can generate a partial animation image faithfully tracking the movement i3 of the eye. On the other hand, since the first imaging unit 2 captures an image of the subject at a predetermined frame rate, when there is a fast moving part in a part of the subject, the part becomes a blurred image. Thus, the first data generation unit 4 cannot generate a three-dimensional image capable of faithfully reproducing the movement i3 of the eye. Accordingly, the first data generation unit 4 can generate a three-dimensional image in consideration of the movement i3 of the eye and can eliminate blurring of the image around the eye by receiving the information of the movement i3 of the eye from the second data generation unit 6 via the information exchange unit 7.

As described above, the first data generation unit 4 and the second data generation unit 6 mutually exchange the information of the line-of-sight direction (gaze) i2 and the movement i3 of the eye via the information exchange unit 7, so that both the data generated by the first data generation unit 4 and the data generated by the second data generation unit 6 can be improved together.

Furthermore, the data generated by the first data generation unit 4 includes, for example, information of the pose i1 of the head. The second imaging unit 3 cannot detect the pose as an event unless the pose i1 of the head of the subject changes. Thus, the data generated by the second data generation unit 6 does not include the information of the pose i1 of the head. Accordingly, the second data generation unit 6 can generate a partial animation image in consideration of the head pose i1 by receiving information of the head pose i1 (pose) from the first data generation unit 4 via the information exchange unit 7.

Furthermore, the data generated by the second data generation unit 6 includes, for example, information of the movement i3 of the mouth. On the other hand, the first data generation unit 4 cannot generate a three-dimensional image capable of faithfully reproducing the movement i3 of the mouth. Accordingly, the first data generation unit 4 can generate a three-dimensional image in consideration of the movement i3 of the mouth and to eliminate blurring of the image around the mouth by receiving the information of the movement i3 of the mouth from the second data generation unit 6 via the information exchange unit 7.

As described above, the first data generation unit 4 and the second data generation unit 6 mutually exchange the information about the pose i1 and the movement i3 of the mouth via the information exchange unit 7, so that both the data generated by the first data generation unit 4 and the data generated by the second data generation unit 6 can be improved together.

Furthermore, the data generated by the second data generation unit 6 includes, for example, information of the skin. The information of the skin generated by the second data generation unit 6 includes, for example, information such as wrinkles and mouth distortion that change as needed while a human speaks. Such information is often recognized as blurring in the image captured by the first imaging unit 2, and is not included in the data generated by the first data generation unit 4, or even if included, the reliability is low. Accordingly, the first data generation unit 4 receives the information of the skin from the second data generation unit 6 via the information exchange unit 7, so that it is possible to generate a three-dimensional image reflecting a change in the skin, a distortion of the mouth, or the like while the human is speaking.

As described above, the first data generation unit 4 and the second data generation unit 6 mutually exchange information of the head pose i1 and the skin via the information exchange unit 7, so that both the data generated by the first data generation unit 4 and the data generated by the second data generation unit 6 can be improved together.

### (Second Specific Example of Information Exchange Unit 7)

In a second specific example of the information exchange unit 7, the same type of information is exchanged between the first data generation unit 4 and the second data generation unit 6.

FIG. 10 is a block diagram illustrating a second specific example of the information exchange unit 7. In the information exchange unit 7 in FIG. 10, for example, the first data generation unit 4 and the second data generation unit 6 mutually exchange information of movement i5 of the eye or pupil, information of face feature points i6, and information of movement i of the mouth or lip.

The first data generation unit 4 detects the movement i5 of the eye or pupil, a face feature point i6, and the movement i of the mouth or lip on the basis of a plurality of images of a plurality of frames captured by the first imaging unit 2. The first imaging unit 2 performs image-capturing at a frame rate slower than that of the second imaging unit 3, but if the movement of the eyes or mouth of the subject is gentle, the first data generation unit 4 can detect the movement i5 of the eye or pupil, the face feature point i6, and the movement i of the mouth or lip with relatively high accuracy. In particular, since the first imaging unit 2 generates an image of the entire region in the effective pixel region, feature points of a portion with little movement can be extracted without omission.

On the other hand, the feature point tracking unit 5 and the second data generation unit 6 detect the movement i5 of the eye or pupil, the face feature points i6, and the movement i of the mouth or lip on the basis of a plurality of images of a plurality of frames captured by the second imaging unit 3. Since the second imaging unit 3 captures an image of a moving part as an event, even if the movement is fast, the second imaging unit 3 can perform imaging at a frame rate corresponding to the movement. Thus, the feature point tracking unit 5 and the second data generation unit 6 can accurately extract the movement i5 of the eye or pupil, the face feature points i6, and the movement 17 of the mouth or lip even if the subject moves the eyes or the mouth at a high speed.

The information exchange unit 7 compares at least one of the information of the movement i5 of the eye or pupil, the information of the face feature points i6, or the information of the movement i of the mouth or lip provided from each of the first data generation unit 4 and the second data generation unit 6, and employs the superior information. For example, in a case where the movement of the eye or mouth is fast and at least one of the information of the movement i5 of the eye or pupil or the information of the movement i of the mouth or lip provided from the first data generation unit 4 is unreliable, the information provided from the second data generation unit 6 is transmitted to the first data generation unit 4. On the other hand, in a case where the movement of the eye or mouth is slow and the information of the movement i5 of the eye or pupil and the information of the movement i of the mouth or lip provided from the first data generation unit 4 accurately reflect the movement, the resolution is higher and color gradation information is also included, and thus the information provided from the first data generation unit 4 is transmitted to the second data generation unit 6.

### (Processing of Animation Generation Unit 8)

The data generated by the first data generation unit 4 after the data exchange by the information exchange unit 7 and the data generated by the second data generation unit 6 are input to the animation generation unit 8. The data generated by the first data generation unit 4 is, for example, a mesh-divided three-dimensional face image. The data generated by the second data generation unit 6 is a partial animation image with movement.

The animation generation unit 8 can generate the first animation image by using the data generated by the second data generation unit 6 for a region with movement in the three-dimensional face image generated by the first data generation unit 4. Thus, a partial region (for example, eye, mouth, or the like) of the animation image corresponding to the three-dimensional face image can be moved in accordance with the movement of the subject.

The data generated by the first data generation unit 4 has a frame rate of about 30 frames/second similar to the frame rate of the image captured by the first imaging unit 2. On the other hand, the data generated by the second data generation unit 6 has a frame rate of about 1,000 frames/second obtained by lowering the frame rate of the image captured by the second imaging unit 3.

For example, the animation generation unit 8 generates the first animation image at a frame rate similar to the frame rate of the data generated by the second data generation unit 6. Thus, a partial region (for example, eye, mouth, or the like) in the animation image can be smoothly moved.

Since the first data generation unit 4 and the second data generation unit 6 exchange data with each other via the information exchange unit 7, movement information, luminance change information, and the like generated by the second data generation unit 6 are reflected in at least a part of the three-dimensional face image generated by the first data generation unit 4. Furthermore, the contour information, the color information, and the like generated by the first data generation unit 4 are reflected in at least a part of the partial animation image generated by the second data generation unit 6. Thus, the first animation image generated by the animation generation unit 8 can smoothly move the eye, the mouth, and the like in accordance with the movement of the subject while retaining high-resolution color gradation information.

### (Hardware Configuration Example of Information Processing Device 1 According to Present Disclosure)

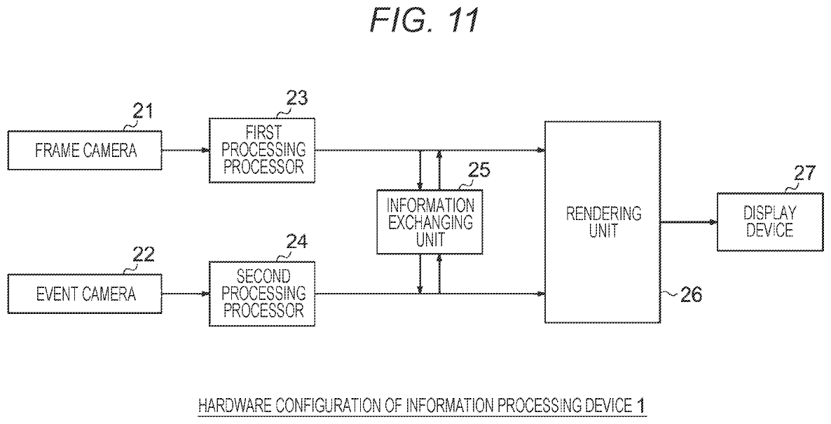

FIG. 11 is a block diagram illustrating an example of a hardware configuration of the information processing device 1 according to the present disclosure. As illustrated in FIG. 11, the information processing device 1 includes a frame camera 21, an event camera 22, a first processing processor 23, a second processing processor 24, an information exchanging unit 25, a rendering unit 26, and a display device 27.

The frame camera 21 corresponds to the first imaging unit 2 in FIG. 1, and is a normal camera that captures a still image or a video image. The frame camera 21 includes an image sensor that captures color gradation information of the entire region in the effective pixel region. The frame camera 21 itself may be an image sensor.

The event camera 22 corresponds to the second imaging unit 3 in FIG. 1 and captures an image of a pixel in which an event has occurred. The event camera 22 is assumed to be an asynchronous camera that captures an image at a timing when an event occurs, but may be a synchronous camera that captures an image of a pixel where the event occurs at a predetermined frame rate. The event camera 22 has a sensor called DVS or EVS. The event camera 22 itself may be a DVS or EVS sensor.

The first processing processor 23 detects depth information on the basis of a two-dimensional image captured by the frame camera 21, performs learning using, for example, CNN or DNN, and then generates a three-dimensional image. The first processing processor 23 performs processing of the first data generation unit 4 in FIG. 1. Specifically, the first processing processor 23 can be configured by a microprocessor (central processing unit (CPU)) or a signal processing processor (digital signal processor (DSP)).

The second processing processor 24 generates a partial animation image on the basis of the image captured by the event camera 22. The second processing processor 24 performs processing of the feature point tracking unit 5 and the second data generation unit 6 in FIG. 1.

Note that the first processing processor 23 and the second processing processor 24 may be integrated into one processing processor (CPU, DSP, or the like).

The information exchanging unit 25 exchanges at least a part of data of the three-dimensional image generated by the first processing processor 23 and at least a part of partial animation data generated by the second processing processor 24 with each other. The information exchanging unit 25 performs processing of the information exchange unit 7 in FIG. 1. The information exchanging unit 25 may be integrated with the first processing processor 23 or the second processing processor 24.

The rendering unit 26 synthesizes the three-dimensional image generated by the first processing processor 23 and the partial animation image generated by the second processing processor 24 to generate an animation image (first animation image). Furthermore, the rendering unit 26 can synthesize the three-dimensional animation model 10 and the animation image (first animation image) to generate a final three-dimensional animation image (second animation image).

The rendering unit 26 performs processing of the animation generation unit 8 and the image synthesis unit 9 in FIG. 1. The three-dimensional animation image generated by the rendering unit 26 is displayed on the display device 27. Furthermore, the three-dimensional animation image can be recorded in a recording device (not illustrated).

Note that the hardware configuration of the information processing device 1 according to the present disclosure is not necessarily limited to FIG. 11, and various modifications can be made. For example, the processing of the information processing device 1 according to the present disclosure may be performed by a personal computer (PC) to which the frame camera 21 and the event camera 22 are connected.

### (Application Field of Information Processing Device 1 According to Present Disclosure)

The information processing device 1 according to the present disclosure can generate a high-resolution animation image that moves smoothly with a simple procedure without requiring a high-performance camera or processor. Thus, the information processing device 1 according to the present disclosure can be mounted on a portable electronic device such as a smartphone, a tablet, or a mobile PC, for example. By being mounted on the portable electronic device, it is possible to process an image obtained by imaging a subject in real time, generate an animation image corresponding to the subject image, and display the animation image on a display unit of the portable electronic device. It is also possible to cooperate with a game application executable by the portable electronic device.

Furthermore, the information processing device 1 according to the present disclosure can be incorporated in an existing motion capture device. Thus, the processing time for generating a three-dimensional image by the motion capture device can be significantly shortened. In particular, it is possible to smoothly move at least a part of the animation image generated on the basis of the three-dimensional image in accordance with movement of the subject while the resolution of the three-dimensional image generated by the motion capture device is kept high.

As a specific example, the information processing device 1 according to the present disclosure can be used in a wide range of applications such as the inside of a vehicle and medical applications. Hereinafter, three representative applications (use cases) will be described.

### (First Use Case)

In a first use case, movement of a human mouth is expressed by an animation image. The first use case is applicable to, for example, a virtual reality immersion conference system using an immersive display in which a plurality of people participates.

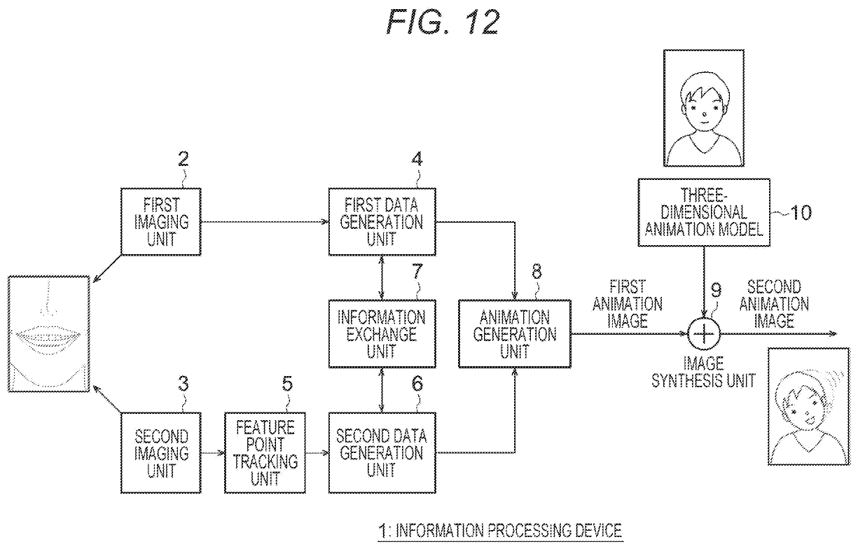

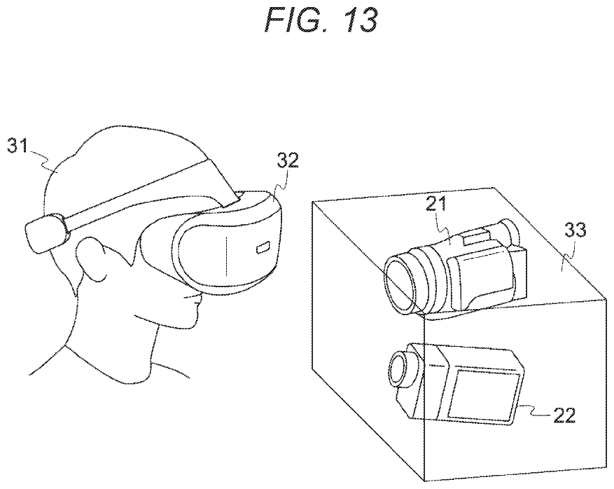

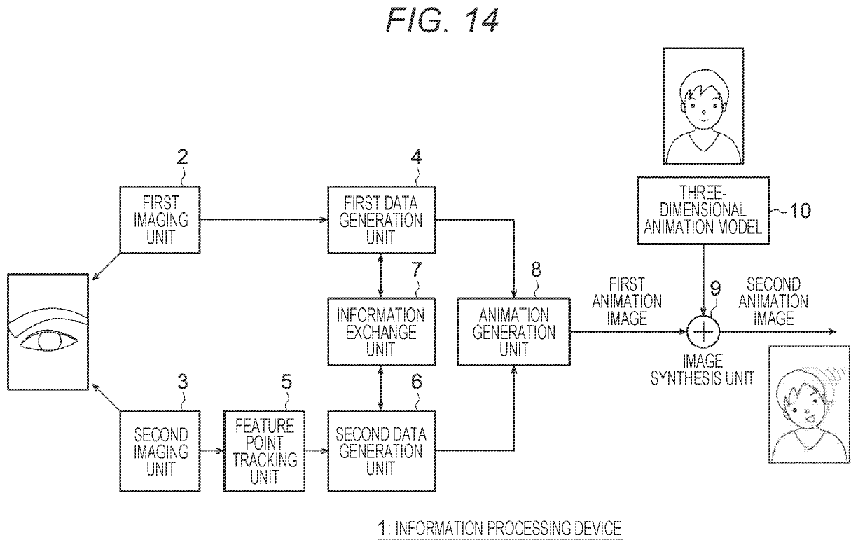

FIG. 12 is a block diagram illustrating a schematic configuration of an information processing device 1 according to the first use case, and FIG. 13 is a diagram illustrating participants of the virtual conference system. As illustrated in FIG. 13, a participant 31 of the virtual conference system wear VR glasses and a head mounted display (hereinafter referred to as HMD) 32. Near the mouth of the participant 31, a camera stack device 33 including the frame camera 21 and the event camera 22 is arranged. The frame camera 21 in the camera stack device 33 capture an image of the periphery of the mouth of the participant 31 at a predetermined frame rate. The event camera 22 in the camera stack device 33 captures an image of movement of the mouth of the participant 31 as an event. Note that the camera stack device 33 may be integrated with a microphone. The participants 31 of a virtual conference or an online conference often wear microphones. By mounting the image sensor for the frame camera 21 and the DVS or EVS for the event camera 22 on the microphone, it is possible to capture an image of the periphery of the user's mouth without causing the user's consciousness.

The information processing device 1 in FIG. 12 is basically configured similarly to FIG. 1, but both the first imaging unit 2 corresponding to the frame camera 21 and the second imaging unit 3 corresponding to the event camera 22 capture images around the human mouth.

The first data generation unit 4 generates data for a three-dimensional image around the human mouth on the basis of the image captured by the first imaging unit 2. The feature point tracking unit 5 tracks movement of the human mouth as a feature point on the basis of the image captured by the first imaging unit 2. The second data generation unit 6 generates data for a partial animation image on the basis of a tracking result of the feature point tracking unit 5.

The information exchange unit 7 exchanges at least a part of the data generated by the first data generation unit 4 and at least a part of the data generated by the second data generation unit 6 with each other. Since the first data generation unit 4 generates a three-dimensional image on the basis of the image captured by the first imaging unit 2, the first data generation unit 4 can generate a three-dimensional image having high resolution and including color gradation information. On the other hand, since the second data generation unit 6 generates the partial animation image on the basis of the image captured by the second imaging unit 3, it is possible to generate the partial animation image faithfully reproducing the movement of the human mouth. By exchanging data between the first data generation unit 4 and the second data generation unit 6 in the information exchange unit 7, it is possible to generate high-quality three-dimensional images and partial animation images.

The animation generation unit 8 generates an animation image (first animation image) corresponding to the periphery of the human mouth on the basis of the data generated by the first data generation unit 4 and the data generated by the second data generation unit 6. The image synthesis unit 9 synthesizes the first animation image generated by the animation generation unit 8 with the three-dimensional animation model 10 to generate a final animation image (second animation image). This animation image is, for example, an animation image corresponding to the entire human face, and can move the mouth in accordance with movement of the mouth of the participant 31 of the virtual conference. This animation image is displayed on the VR glass, the HMD 32, or the like in FIG. 13. Thus, all the participants 31 of the virtual conference can visually recognize movement of the mouth of the speaker in the animation image.

### (Second Use Case)

In a second use case, the information processing device 1 according to the present disclosure is applied to an eye tracking system that tracks a line of sight of human eyes.

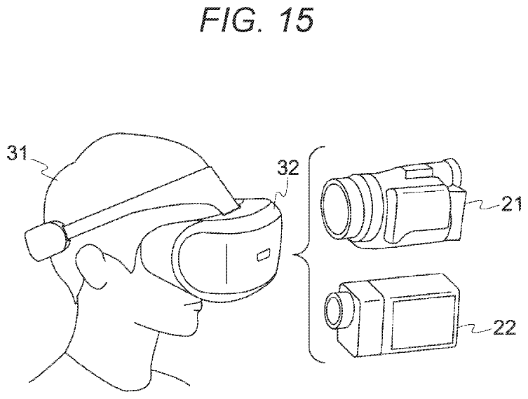

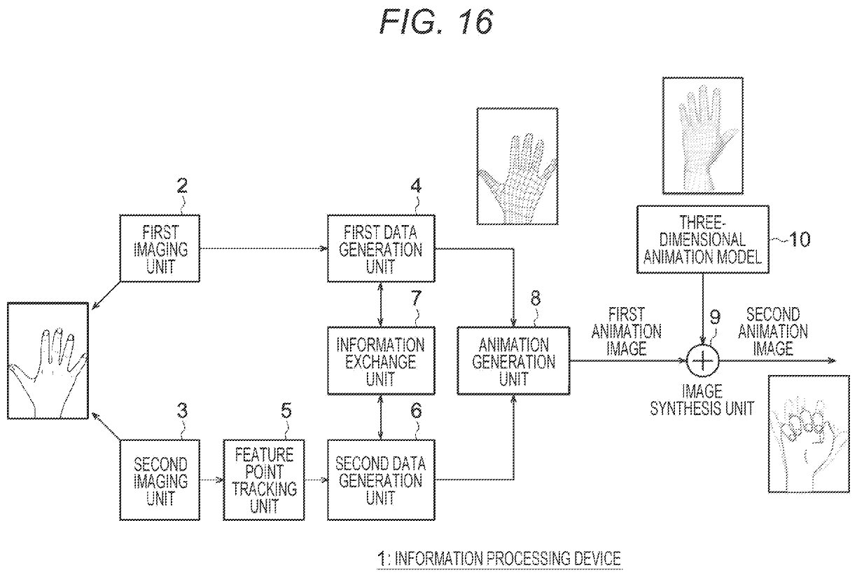

FIG. 14 is a block diagram illustrating a schematic configuration of an information processing device 1 according to a second use case. In the second use case, similarly to the first use case, a person as a target of performing eye tracking wears VR glasses or the HMD 32. FIG. 15 is a diagram illustrating a human wearing VR glasses or the HMD 32. In the VR glasses or the HMD 32, an image sensor for the frame camera 21 and DVS or EVS for the event camera 22 are mounted. The frame camera 21 captures an image of the surroundings of the eyes of the wearer of the VR glasses or the HMD 32 at a predetermined frame rate. The event camera 22 captures an image of movement of the eyes of the wearer of the VR glasses or the HMD 32 as an event.

Similarly to the information processing device 1 of FIG. 12, the information processing device 1 of FIG. 14 is also applicable to a virtual conference system using an immersive display in which a plurality of people participates.

The information processing device 1 of FIG. 14 is basically configured similarly to the information processing device 1 of FIG. 12, but is different from the information processing device 1 of FIG. 12 in that both the first imaging unit 2 corresponding to the frame camera 21 and the second imaging unit 3 corresponding to the event camera 22 capture images around human eyes.

The first data generation unit 4 generates data for a three-dimensional image around human eyes on the basis of the image captured by the first imaging unit 2. The feature point tracking unit 5 tracks movement of human eyes as feature points on the basis of the image captured by the first imaging unit 2. The second data generation unit 6 generates data for a partial animation image on the basis of a tracking result of the feature point tracking unit 5.

The information exchange unit 7 exchanges at least a part of the data generated by the first data generation unit 4 and at least a part of the data generated by the second data generation unit 6 with each other. Since the first data generation unit 4 generates a three-dimensional image on the basis of the image captured by the first imaging unit 2, the first data generation unit 4 can generate a three-dimensional image having high resolution and including color gradation information. On the other hand, since the second data generation unit 6 generates a partial animation image on the basis of the image captured by the second imaging unit 3, it is possible to generate the partial animation image faithfully reproducing the movement of human eyes. The information exchange unit 7 exchanges a line-of-sight direction (gaze), movement of the eye, a shape around the eye, color gradation information, and the like between the first data generation unit 4 and the second data generation unit 6.

The animation generation unit 8 generates the first animation image corresponding to the periphery of human eyes on the basis of the data generated by the first data generation unit 4 and the data generated by the second data generation unit 6. The image synthesis unit 9 synthesizes the first animation image generated by the animation generation unit 8 with the three-dimensional animation model 10 to generate the final animation image (second animation image). This animation image is an animation image corresponding to the entire human face, and can move the eyes in accordance with movement of the eyes of the participant 31 of the virtual conference. This animation image is displayed on a VR glass or the like in FIG. 15. Thus, all the participants 31 of the virtual conference can visually recognize movement of the eyes of the speakers by the animation image.

### (Third Use Case)

Although the first and second use cases relate to a human face, the information processing device 1 of the present disclosure is applicable to other than a face. In a third use case, the information processing device 1 according to the present disclosure is applied to a hand system that expresses movement of a human hand with an animation image.

FIG. 16 is a block diagram illustrating a schematic configuration of the information processing device 1 according to a third use case. The information processing device 1 of FIG. 16 basically has a configuration similar to that of FIG. 1. In the information processing device 1 of FIG. 16, the frame camera 21 and the event camera 22 image a human hand. At this time, when the hand is moved or a finger is bent or stretched, the event camera 22 captures an image of the movement of the hand including the finger as an event. The first data generation unit 4 generates a three-dimensional image of the human hand on the basis of the image captured by the first imaging unit 2. The feature point tracking unit 5 tracks movement of the human hand. Furthermore, the feature point tracking unit 5 can track movement of a wrinkle of the skin of the hand as a feature point by a luminance change.

The second data generation unit 6 generates a partial animation image simulating movement of the human hand on the basis of a tracking result of the feature point extraction unit 17. Since the first data generation unit 4 generates a three-dimensional image on the basis of an image having high resolution captured by the first imaging unit 2 and including color gradation information, the first data generation unit 4 can generate a three-dimensional image that faithfully reflects the shape and hue of the human hand. Furthermore, the second data generation unit 6 can generate a partial animation image capable of faithfully reproducing movement of the hand including the finger.

The animation generation unit 8 generates the first animation image simulating the human hand on the basis of the three-dimensional image generated by the first data generation unit 4 and the partial animation image generated by the second data generation unit 6. By combining the three-dimensional image generated by the first data generation unit 4 and the partial animation image generated by the second data generation unit, it is possible to generate an animation image (first animation image) that faithfully reproduces the movement of the hand including the finger while reproducing the shape and color of the human hand with high resolution.

The image synthesis unit 9 synthesizes the first animation image generated by the animation generation unit 8 with the three-dimensional animation model 10 related to the human hand to generate the final animation image (second animation image).

### (Extended Function of Information Processing Device 1)

In the above-described information processing device 1 illustrated in FIGS. 1 to 16, an example has been illustrated in which one frame camera 21 and one event camera 22 are provided, but a plurality of at least one of the frame cameras 21 or the event cameras 22 may be provided. By providing the plurality of at least one of the frame camera 21 or the event camera 22, depth information can be acquired similarly to the stereo camera, and reliability of the three-dimensional image can be enhanced.

In addition to the frame camera 21 and the event camera 22, a camera having a special function may be provided. The camera having a special function is, for example, a camera capable of detecting depth information of a subject. A representative example of a camera capable of detecting depth information is a time of flight (ToF) camera that detects distance information. If depth information of the subject can be detected by the ToF camera or the like, the first data generation unit 4 can generate a more accurate three-dimensional image.

Furthermore, the camera having a special function may be a camera including a temperature sensor capable of measuring the surface temperature of the subject. Moreover, the camera having a special function may be a high dynamic range (HDR) camera that widens a dynamic range by generating an image obtained by synthesizing a plurality of images continuously captured under a plurality of exposure conditions.

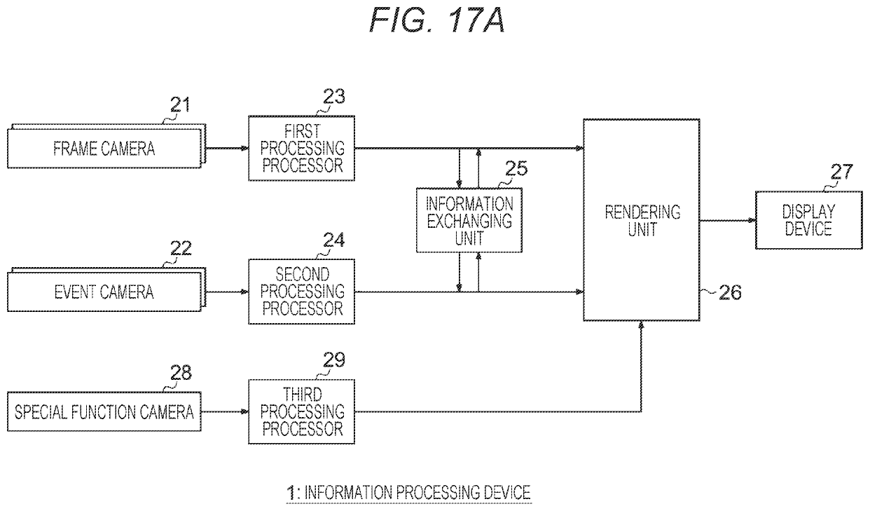

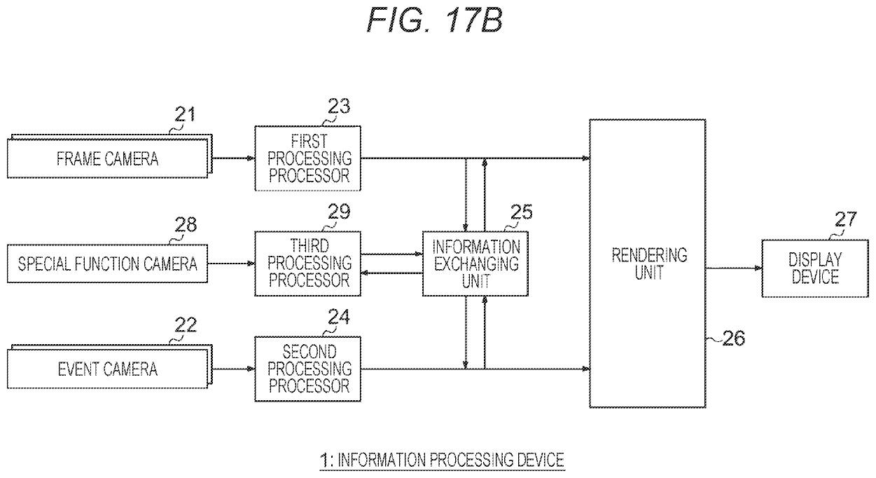

FIGS. 17A and 17B are block diagrams of the information processing device 1 including a camera (hereinafter referred to as a special function camera) 28 having a special function and a third processing processor 29 in addition to the frame camera 21 and the event camera 22. The information processing device 1 in FIGS. 17A and 17B illustrates an example in which a plurality of frame cameras 21 and a plurality of event cameras 22 are provided, but the information processing device 1 does not necessarily need to include the plurality of frame cameras 21 and the plurality of event cameras 22. Furthermore, the information processing device 1 in FIGS. 17A and 17B includes at least one special function camera 28 in addition to the frame camera 21 and the event camera 22. The special function camera 28 may be a camera that detects depth information of a subject, may be a ToF camera, may be a camera having a temperature sensor, or may be an HDR camera. An imaging result of the special function camera 28 is input to the third processing processor 29, and data indicating depth information, temperature information, and the like is generated.

In the information processing device 1 of FIG. 17A, data generated by the third processing processor 29 is sent to, for example, the rendering unit 26. The rendering unit 26 generates a three-dimensional image or an animation image in consideration of information captured by the special function camera 28. The third processing processor 29 may be integrated with the first processing processor 23 or the second processing processor 24.

In the information processing device 1 of FIG. 17B, the data generated by the third processing processor 29 is provided to the information exchanging unit 25. Thus, the information exchanging unit 25 can share the data generated by each of the first to third processing processors 23, 24, and 29. Therefore, at least one of the first processing processor 23 or the second processing processor 24 can generate at least one of data to be converted into a three-dimensional image and data for a partial animation image on the basis of an image captured by the special function camera 28.

By increasing the number of various cameras provided in the information processing device 1, the number of images captured by each camera can be increased. The increase in the number of images means that the amount of information regarding the subject can be acquired more, and the quality of the three-dimensional image and the three-dimensional animation image (second animation image) generated by the rendering unit 26 can be improved.

(Technical effects of information processing device 1) As described above, in the information processing device 1 according to the present disclosure, the first data generation unit 4 generates a three-dimensional image on the basis of the image captured by the frame camera 21 (first imaging unit 2), and the second data generation unit 6 generates a partial animation image on the basis of the image captured by the event camera 22 (second imaging unit 3). The information exchange unit 7 exchanges data for the three-dimensional image generated by the first data generation unit 4 with data for the partial animation image generated by the second data generation unit 6. Thus, the quality of the three-dimensional image generated by the first data generation unit 4 and the partial animation image generated by the second data generation unit 6 can be improved.

Thereafter, the animation generation unit 8 generates the first animation image by combining the three-dimensional image generated by the first data generation unit 4 and the partial animation image generated by the second data generation unit 6. Thus, it is possible to smoothly move the eyes, mouth, and the like of the animation image in accordance with the movement of the eyes, mouth, and the like of the subject while retaining the contour and color information of the subject.

Moreover, by synthesizing the first animation image generated by the animation generation unit 8 and the three-dimensional animation model 10, the subject can be converted into any animation model, and then the eyes, mouth, and the like of the second animation image can be smoothly moved in accordance with the movement of the eyes, mouth, and the like of the subject.

The information processing device 1 according to the present disclosure shares the advantages and compensates for shortages of the frame camera 21 and the event camera 22, and thus can quickly generate a high-quality animation image in a simple procedure while using the commercially available relatively inexpensive frame camera 21 and event camera 22.

At least a part of the information processing device 1 described in the above-described embodiment may be configured by hardware or software. In a case where the information processing device 1 is configured by software, a program for implementing at least a part of functions of the information processing device 1 may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, a program for implementing at least a part of functions of the information processing device 1 may be distributed via a communication line (including wireless communication) such as the Internet. Moreover, the program may be distributed via a wired line or a wireless line such as the Internet or stored in a recording medium in an encrypted, modulated, or compressed state.

Note that the present technology can have the following configurations.

(1) An information processing device, including:
a first imaging unit that captures an image of an entire effective pixel region at a predetermined frame rate;
a second imaging unit that captures an image of a pixel in which an event has occurred;
a first data generation unit that generates data for converting a two-dimensional image captured by the first imaging unit into a three-dimensional image;
a feature point tracking unit that detects a feature point included in the image captured by the second imaging unit and tracks movement of the detected feature point;
a second data generation unit that generates data for a partial animation image simulating movement of the feature point on the basis of a tracking result of the movement of the feature point; and an information exchange unit that exchanges at least a part of the data generated by the first data generation unit with at least a part of the data generated by the second data generation unit.

(2) The information processing device according to (1), in which
the first data generation unit generates data for converting the two-dimensional image into a three-dimensional image on the basis of the two-dimensional image captured by the first imaging unit and at least a part of the data generated by the second data generation unit provided from the information exchange unit, and
the second data generation unit generates the data for the partial animation image on the basis of a tracking result of the movement of the feature point and at least a part of the data generated by the first data generation unit provided from the information exchange unit.

(3) The information processing device according to (2), in which
the first imaging unit and the second imaging unit capture an image of a face of a subject, and
the information exchange unit provides the second data generation unit with data regarding at least one of a pose of a head or a line-of-sight direction of the subject included in the data generated by the first data generation unit, and provides the first data generation unit with data regarding at least one of movement of an eye or a mouth or a state change of skin of the subject included in the data generated by the second data generation unit.

(4) The information processing device according to any one of (1) to (3), in which the information exchange unit receives provision of different types of data from each of the first data generation unit and the second data generation unit, and exchanges data between the first data generation unit and the second data generation unit.

(5) The information processing device according to any one of (1) to (3), in which the information exchange unit receives provision of a same type of data from each of the first data generation unit and the second data generation unit, and shares highly reliable data among provided data between the first data generation unit and the second data generation unit.

(6) The information processing device according to any one of (1) to (5), in which the second imaging unit outputs an image including a pixel in which the event has occurred at a higher frame rate than the first imaging unit.

(7) The information processing device according to (6), in which the second imaging unit outputs the image in accordance with timing at which the event occurs.

(8) The information processing device according to any one of (1) to (7), further including an animation generation unit that generates a first animation image on the basis of the data generated by the first data generation unit and the second data generation unit with which at least a part of data has been exchanged by the information exchange unit.

(9) The information processing device according to (8), in which the animation generation unit generates the first animation image by synthesizing the partial animation image generated by the second data generation unit with a three-dimensional image generated by the first data generation unit.

(10) The information processing device according to (8) or (9), further including an image synthesis unit that synthesizes the first animation image and a three-dimensional animation model image to generate a second animation image.

(11) The information processing device according to claim 10, in which the three-dimensional animation model image is a three-dimensional animation image independent of a subject imaged by the first imaging unit and the second imaging unit.

(12) The information processing device according to (10) or (11), in which the first animation image and the second animation image perform movement according to movement of a subject.

(13) The information processing device according to any one of (1) to (12), in which the first data generation unit extracts a feature point from a two-dimensional image captured by the first imaging unit, and generates the three-dimensional image on the basis of the extracted feature point.

(14) The information processing device according to (13), in which the first data generation unit extracts a face included in the two-dimensional image captured by the first imaging unit, and generates the three-dimensional image on the basis of at least one of a feature point of the extracted face, a pose of a head, or a line-of-sight direction.

(15) The information processing device according to any one of (1) to (14), in which the feature point tracking unit tracks the feature point by detecting movement of the feature point between images of different frames captured by the second imaging unit.

(16) The information processing device according to any one of (1) to (15), in which the second data generation unit includes a frame rate conversion unit that generates the partial animation image in which a frame rate of the image captured by the second imaging unit is lowered to a frame rate suitable for an animation image.

(17) The information processing device according to any one of (1) to (16), in which the second data generation unit includes
a feature point image generation unit that generates a three-dimensional image corresponding to the image captured by the second imaging unit,
a surface normal calculation unit that calculates a surface normal of the three-dimensional image,
an object detection unit that detects an object included in the three-dimensional image,
a region-of-interest extraction unit that extracts a region of interest included in the three-dimensional image, and
a feature point extraction unit that extracts a feature point included in the three-dimensional image, and
the second data generation unit generates data for the partial animation image simulating movement of the feature point on the basis of the three-dimensional image generated by the feature point image generation unit, the surface normal calculated by the surface normal calculation unit, the object detected by the object detection unit, the region of interest extracted by the region-of-interest extraction unit, and the feature point extracted by the feature point extraction unit.

(18) The information processing device according to any one of (1) to (17), in which a plurality of at least one of the first imaging units or the second imaging units is provided.

(19) The information processing device according to any one of (1) to (18), further including:
a third imaging unit that is provided separately from the first imaging unit and the second imaging unit and captures an image including at least one of depth information of a subject, distance information to the subject, or temperature information of the subject, in which
at least one of the first data generation unit or the second data generation unit generates at least one of data to be converted into a three-dimensional image or data for the partial animation image on the basis of an image captured by the third imaging unit.

(20) An electronic device, including:
an information processing device that generates a three-dimensional animation image; and
a display device that displays the three-dimensional animation image, in which
the information processing device includes
a first imaging unit that captures an image of an entire effective pixel region at a predetermined frame rate,
a second imaging unit that captures an image of a pixel in which an event has occurred,
a first data generation unit that generates data for converting a two-dimensional image captured by the first imaging unit into a three-dimensional image,
a feature point tracking unit that detects a feature point included in the image captured by the second imaging unit and tracks movement of the detected feature point,
a second data generation unit that generates data for a partial animation image simulating movement of the feature point on the basis of a tracking result of the movement of the feature point,
an information exchange unit that exchanges at least a part of the data generated by the first data generation unit with at least a part of the data generated by the second data generation unit,
an animation generation unit that generates a first animation image on the basis of the data generated by the first data generation unit and the second data generation unit with which at least a part of data has been exchanged by the information exchange unit, and
an image synthesis unit that synthesizes the first animation image and a three-dimensional animation model image to generate a second animation image, and
the display device displays the second animation image.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Information processing device
2 First imaging unit
3 Second imaging unit
4 First data generation unit
5 Feature point tracking unit
6 Second data generation unit
7 Information exchange unit
8 Animation generation unit
9 Image synthesis unit
10 Three-dimensional animation model
11 Frame rate conversion unit
12 Processing module
13 Feature point image generation unit
14 Surface normal calculation unit
15 Object detection unit
16 Region-of-interest extraction unit
17 Feature point extraction unit
21 Frame camera
22 Event camera
23 Third processing processor
23 First processing processor
24 Third processing processor
24 Second processing processor
25 Information exchanging unit
26 Rendering Unit
27 Display device
28 Special function camera
28 Special function camera
29 Third processing processor
31 Participant
32 Head mounted display (HMD)
33 Camera stack device

1. An information processing device, comprising:
a first imaging unit that captures an image of an entire effective pixel region at a predetermined frame rate;
a second imaging unit that captures an image of a pixel in which an event has occurred;
a first data generation unit that generates data for converting a two-dimensional image captured by the first imaging unit into a three-dimensional image;
a feature point tracking unit that detects a feature point included in the image captured by the second imaging unit and tracks movement of the detected feature point;
a second data generation unit that generates data for a partial animation image simulating movement of the feature point on a basis of a tracking result of the movement of the feature point; and
an information exchange unit that exchanges at least a part of the data generated by the first data generation unit with at least a part of the data generated by the second data generation unit.

2. The information processing device according to claim 1, wherein
the first data generation unit generates data for converting the two-dimensional image into a three-dimensional image on a basis of the two-dimensional image captured by the first imaging unit and at least a part of the data generated by the second data generation unit provided from the information exchange unit, and
the second data generation unit generates the data for the partial animation image on a basis of a tracking result of the movement of the feature point and at least a part of the data generated by the first data generation unit provided from the information exchange unit.

3. The information processing device according to claim 2, wherein
the first imaging unit and the second imaging unit capture an image of a face of a subject, and
the information exchange unit provides the second data generation unit with data regarding at least one of a pose of a head or a line-of-sight direction of the subject included in the data generated by the first data generation unit, and provides the first data generation unit with data regarding at least one of movement of an eye or a mouth or a state change of skin of the subject included in the data generated by the second data generation unit.

4. The information processing device according to claim 1, wherein the information exchange unit receives provision of different types of data from each of the first data generation unit and the second data generation unit, and exchanges data between the first data generation unit and the second data generation unit.

5. The information processing device according to claim 1, wherein the information exchange unit receives provision of a same type of data from each of the first data generation unit and the second data generation unit, and shares highly reliable data among provided data between the first data generation unit and the second data generation unit.

6. The information processing device according to claim 1, wherein the second imaging unit outputs an image including a pixel in which the event has occurred at a higher frame rate than the first imaging unit.

7. The information processing device according to claim 6, wherein the second imaging unit outputs the image in accordance with timing at which the event occurs.

8. The information processing device according to claim 1, further comprising an animation generation unit that generates a first animation image on a basis of the data generated by the first data generation unit and the second data generation unit with which at least a part of data has been exchanged by the information exchange unit.

9. The information processing device according to claim 8, wherein the animation generation unit generates the first animation image by synthesizing the partial animation image generated by the second data generation unit with a three-dimensional image generated by the first data generation unit.

10. The information processing device according to claim 8, further comprising an image synthesis unit that synthesizes the first animation image and a three-dimensional animation model image to generate a second animation image.

11. The information processing device according to claim 10, wherein the three-dimensional animation model image is a three-dimensional animation image independent of a subject imaged by the first imaging unit and the second imaging unit.

12. The information processing device according to claim 10, wherein the first animation image and the second animation image perform movement according to movement of a subject.

13. The information processing device according to claim 1, wherein the first data generation unit extracts a feature point from a two-dimensional image captured by the first imaging unit, and generates the three-dimensional image on a basis of the extracted feature point.

14. The information processing device according to claim 13, wherein the first data generation unit extracts a face included in the two-dimensional image captured by the first imaging unit, and generates the three-dimensional image on a basis of at least one of a feature point of the extracted face, a pose of a head, or a line-of-sight direction.

15. The information processing device according to claim 1, wherein the feature point tracking unit tracks the feature point by detecting movement of the feature point between images of different frames captured by the second imaging unit.

16. The information processing device according to claim 1, wherein the second data generation unit includes a frame rate conversion unit that generates the partial animation image in which a frame rate of the image captured by the second imaging unit is lowered to a frame rate suitable for an animation image.

17. The information processing device according to claim 1, wherein
the second data generation unit includes
a feature point image generation unit that generates a three-dimensional image corresponding to the image captured by the second imaging unit,
a surface normal calculation unit that calculates a surface normal of the three-dimensional image,
an object detection unit that detects an object included in the three-dimensional image,
a region-of-interest extraction unit that extracts a region of interest included in the three-dimensional image, and
a feature point extraction unit that extracts a feature point included in the three-dimensional image, and
the second data generation unit generates data for the partial animation image simulating movement of the feature point on a basis of the three-dimensional image generated by the feature point image generation unit, the surface normal calculated by the surface normal calculation unit, the object detected by the object detection unit, the region of interest extracted by the region-of-interest extraction unit, and the feature point extracted by the feature point extraction unit.

18. The information processing device according to claim 1, wherein a plurality of at least one of the first imaging units or the second imaging units is provided.

19. The information processing device according to claim 1, further comprising:
a third imaging unit that is provided separately from the first imaging unit and the second imaging unit and captures an image including at least one of depth information of a subject, distance information to the subject, or temperature information of the subject, wherein
at least one of the first data generation unit or the second data generation unit generates at least one of data to be converted into a three-dimensional image or data for the partial animation image on a basis of an image captured by the third imaging unit.

20. An electronic device, comprising:
an information processing device that generates a three-dimensional animation image; and
a display device that displays the three-dimensional animation image, wherein
the information processing device includes
a first imaging unit that captures an image of an entire effective pixel region at a predetermined frame rate,
a second imaging unit that captures an image of a pixel in which an event has occurred,
a first data generation unit that generates data for converting a two-dimensional image captured by the first imaging unit into a three-dimensional image,
a feature point tracking unit that detects a feature point included in the image captured by the second imaging unit and tracks movement of the detected feature point,
a second data generation unit that generates data for a partial animation image simulating movement of the feature point on a basis of a tracking result of the movement of the feature point,
an information exchange unit that exchanges at least a part of the data generated by the first data generation unit with at least a part of the data generated by the second data generation unit,
an animation generation unit that generates a first animation image on a basis of the data generated by the first data generation unit and the second data generation unit with which at least a part of data has been exchanged by the information exchange unit, and
an image synthesis unit that synthesizes the first animation image and a three-dimensional animation model image to generate a second animation image, and
the display device displays the second animation image.
